(19) United States
(12) Patent Application Publication
(10) Pub. No.: US 2010/0271281 A1
(43) Pub. Date: Oct. 28, 2010

(54) HOUSING WITH BUILT-IN ANTENNA AND METHOD FOR FABRICATING THE SAME

(75) Inventors: BEN-DING TSAO, Shindian (TW); WEN-LIN XIONG, Shenzhen City (CN); FEI-FEI HUANG, Shenzhen City (CN); GUO-HUA ZHANG, Shenzhen City (CN); QI-QUAN YAN, Shenzhen City (CN); WEI GAO, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/634,787

(22) Filed: Dec. 10, 2009

(30) Foreign Application Priority Data
Apr. 27, 2009 (CN) 200910301883.9

(51) Int. Cl. H01Q 1/40; B29C 45/16

(52) U.S. Cl. 343/873; 264/272.11

(57) ABSTRACT

A housing with a built-in antenna includes a film layer, an antenna layer, a base layer; and at least a connecting pole. The antenna layer is comprised from electro-conductive inks and printed on the film layer, the housing is formed by injection molding a molten plastic material over the film layer, the base layer is formed after the molten plastic material cooled, the antenna layer is embedded between the film layer and the base layer, the connecting pole is embedded in the base layer with an end of the connecting pole contacting the antenna and the other end of the connecting pole exposed to the out side.

### CROSS-REFERENCE TO RELATED APPLICATION

This application is related to co-pending U.S. Patent Application (Attorney Docket No. US26569, entitled “HOUSING WITH BUILT-IN ANTENNA AND METHOD FOR FABRICATING THE SAME”, by BEN-DING TSAO et al., which is the same assignee as the present application. The above-identified application is incorporated herein by reference.

### BACKGROUND

1. Technical Field

The present disclosure relates to housings, and especially relates to a housing with a built-in antenna, and a method for fabricating the housing.

2. Description of related art

Portable electronic devices generally use antennas for receiving and/or sending signals. The antenna is usually assembled inside the portable electronic device by of adhering or hot melting the antenna to a circuit board, which increases costs. Additionally, it can be difficult to arrange the antenna and many other electronic components inside the portable electronic device, if it is desired that the portable electronic device be smaller and more portable.

Therefore, there is room for improvement within the art.

### BRIEF DESCRIPTION OF THE DRAWINGS

Many aspects of the housing with a built-in antenna and method for fabricating the housing can be better understood with reference to the following drawings. The components in the drawings are not necessarily drawn to scale, the emphasis instead being placed upon clearly illustrating the principles of the exemplary embodiment. Moreover, in the drawings, like reference numerals designate corresponding parts throughout the several views.

FIG. 1 is an exploded isometric view of a housing with built-in antenna according to an exemplary embodiment.

FIG. 2 is an isometric view of the housing shown in FIG. 1.

FIG. 3 is a schematic view of fabricating the housing shown in FIG. 2.

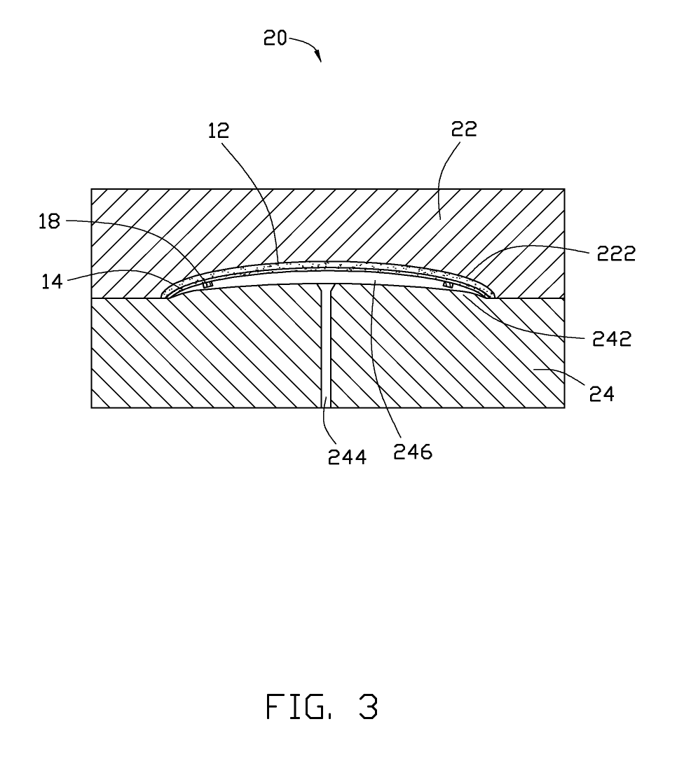

### DETAILED DESCRIPTION

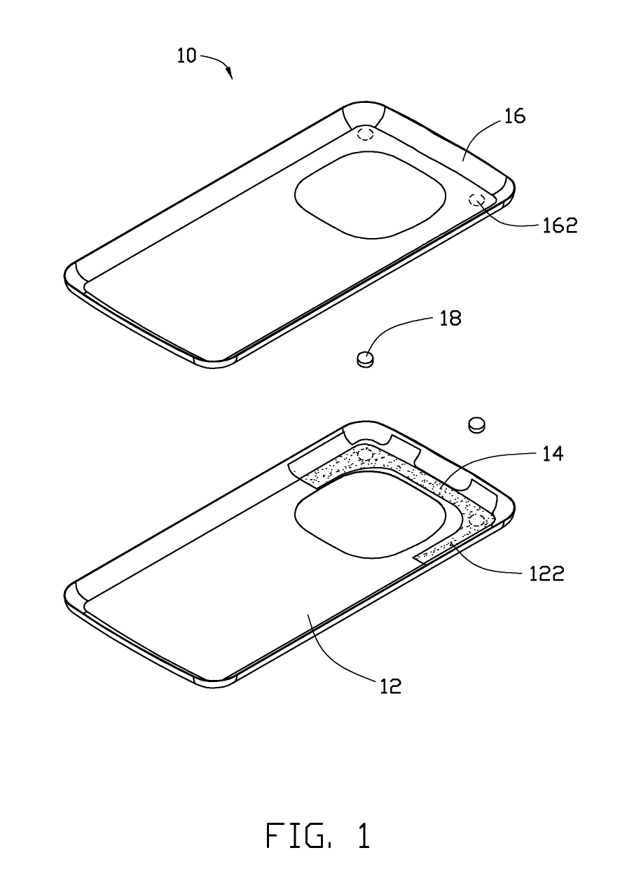

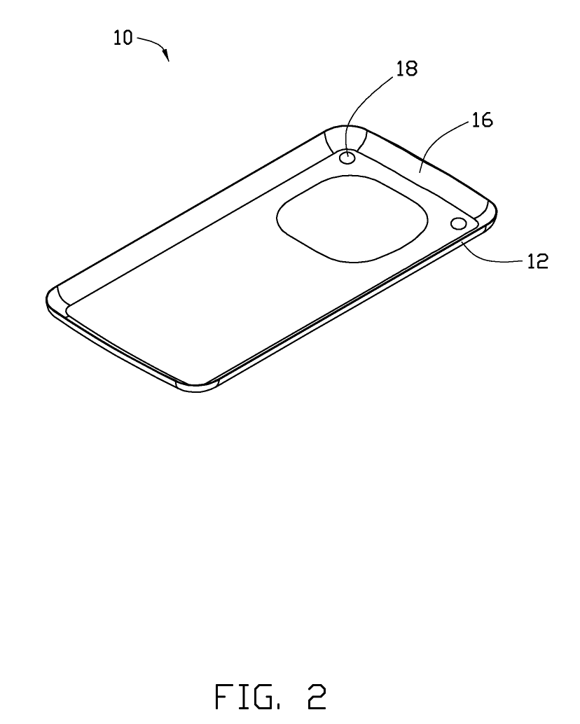

FIG. 1 and FIG. 2 show an exemplary housing 10 with a built-in antenna for portable electronic devices such as mobile phones, etc.

The housing 10 includes a film layer 12, an antenna layer 14, a base layer 16, and two connecting poles 18. The antenna layer 14 is embedded between the film layer 12 and the base layer 16. The connecting poles 18 are affixed on the antenna layer 14 and extend through the base layer 16 to outside.

The film layer 12 can be made of a transparent and thermoplastic macromolecular material such as polycarbonate, polyethylene terephthalate or a combination thereof. The film layer 12 has superior high temperature-resistant capability and can be used in injection molding to be combined with a molten plastic material. The film layer 12 has an antenna forming area 122, which can be printed with an electro-conductive ink to form the antenna layer 14 thereon. The film layer 12 also can be printed on with colored inks to form patterns (not shown) thereon.

The antenna layer 14 can be comprised of an electro-conductive ink which is printed on the antenna forming area 122 of the film layer 12. The electro-conductive ink can be made by adding conductive materials to a solvent. The conductive material may include one or more of gold, silver, copper, carbon and so on. The thickness of the antenna layer 14 is exemplarily ranged from about 0.002 mm (millimeter) to about 0.015 mm.

The base layer 16 can be formed by injection molding a molten plastic material over the film layer 12. The base layer 16 is formed from any one or more plastic material such as PE (polyethylene), PA (polyamide), PC (polycarbonate), ABS (acrylonitrile butadient styrene), PMMA (polymethyl methacrylate) and PET (polyethylene terephthalate). The base layer 16 includes two apertures 162 for the connecting poles 18 engaging therein.

The connecting poles 18 can be made from a conductive metal such as a copper. The connecting poles 18 are affixed on the antenna layer 14 with one end of each passing through the base layer 16 to be exposed to the outside. When the housing 10 is assembled , the exposed ends of the connecting poles 18 resist against the circuit board and electronically connect the antenna layer 14 to inner circuitry of the electronic device.

A method of making the housing 10 may include at least the following steps.

The film layer 12 is provided with an antenna forming area 122. An electro-conductive ink is printed on the antenna forming area 122 to form an antenna layer 14 on the film layer 12. It is to be understood, that the film layer 12 can include decorative patterns printed thereon.

The film layer 12 is hot- pressed and cut to achieve a three-dimensional preformed film layer 12. Two connecting poles 18 are adhered to the antenna layer 14. Referring to FIG. 4, a mold 20 is provided including a female plate 22 and a male plate 24 engagable with the female plate 22. The female plate 22 defines a cavity 222, the male plate 24 forms a core 242 to engage with the cavity 222. The male plate 24 defines a channel 244 through the core 242 to guide molten plastic material into the cavity 222. The film layer 12 adhered to the connecting poles 18 is placed into the cavity 222 with the surface not having the antenna layer 14 abutting the bottom surface of the cavity 222. The mold 20 is closed with the male plate 24 engaging with the female plate 22 and the core 242 reaching into the cavity 222. A chamber 246 is thus enclosed corresponding to the base layer 16 in shape and size. Then, a molten plastic material is injected through the channel 244 into the chamber 246. The molten plastic material integrally combines with the film layer 12 and cools to form the base layer 16. At this time, the antenna layer 14 is embedded between the film layer 12 and the base layer 16, the connecting poles 18 are exposed to outside through the base layer 16. The housing 10 is thus formed and removed after the mold 20 is opened.

It is to be understood that, to securely interlock the film layer 12 with the base layer 16, the film layer 12 can be attached with an adhesive layer (not shown) on the surface having the antenna layer 14 before molding.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A housing having a built-in antenna, comprising:
a film layer;
an antenna layer;
a base layer; and
at least a connecting pole;
wherein the antenna layer comprises electro-conductive inks printed on the film layer, the housing is formed by injection molding a molten plastic material in combination with the film layer, the base layer is formed after the molten plastic material cools, the antenna layer embedded between the film layer and the base layer, the connecting pole embedded in the base layer with an end of the connecting pole contacting the antenna and the other end of the connecting pole exposed to the out side .

2. The housing as claimed in claim 1, wherein the film layer can be made of transparent and thermoplastic macromolecular material such as polycarbonate, polyethylene terephthalate or a combination thereof.

3. The housing as claimed in claim 1, wherein the film layer has an antenna forming area to print an electro-conductive ink thereon thus to form the antenna layer.

4. The housing as claimed in claim 1, wherein the thickness of the antenna layer is from about 0.002 mm (millimeter) to about 0.015 mm.

5. The housing as claimed in claim 1, wherein the base layer is formed from any one or more of the plastic material such as PE (polyethylene), PA (polyamide), PC (polycarbonate), ABS (acrylonitrile butadient styrene), PMMA (polymethyl methacrylate) and PET (polyethylene terephthalate).

6. The housing as claimed in claim 1, wherein the connecting pole can be made from a conductive metal such as a copper.

7. A method for fabricating a housing having a built-in antenna, comprising:
providing a film layer having an antenna forming area;
printing an electro-conductive ink on the antenna forming area to form an antenna layer;
providing a connecting pole, the connecting pole adhered to the antenna layer;
placing the film layer into a mold, injecting a molten plastic material into the mold, the molten plastic material combining with the film layer, the base layer formed after the molten plastic material cools, the antenna layer embedded between the film layer and the base layer, the connecting pole embedded in the base layer with an end of the connecting pole contacting the antenna and the other end of the connecting pole exposed to the outside.

8. The method as claimed in claim 7, wherein before adhering the connecting pole to the antenna layer, the film layer is hot-press and cut to achieve a three-dimensional preformed film layer.

9. The method as claimed in claim 7, wherein the thickness of the antenna layer is from about 0.002 mm (millimeter) to about 0.015 mm.

10. The method as claimed in claim 7, wherein the connecting pole is made from a conductive metal.
